(19) United States
(12) Patent Application Publication
(10) Pub. No.: US 2010/0229436 A1
(43) Pub. Date: Sep. 16, 2010

(54) Color-coded gas cylinder collar

(76) Inventor: Frederick W. Zeyfang, Erie, PA (US)

Correspondence Address: Muncy, Geissler, Olds & Lowe, PLLC, 4000 Legato Road, Suite 310, FAIRFAX, VA, 22033, US

(21) Appl. No.: 12/585,207

(22) Filed: Sep. 8, 2009

Related U.S. Application Data
(60) Provisional application No. 61/136,437, filed on Sep. 5, 2008.

(51) Int. Cl. G09F 3/02

(52) U.S. Cl. 40/306

(57) ABSTRACT

A gas cylinder collar is provided comprising a planar collar having a through-hole generally centrally positioned in the collar, the collar having opposing surfaces, one of the surfaces being comprised of at least one pre-selected indicia color, and the opposing surface being comprised of a different pre-selected indicia color, the respective indicia colors on one of the opposing surfaces being indicative of one or more of the type of gas in the gas cylinder and/or the source of the gas, and/or the customer, while the indicia color of the opposing surface being indicative of the gas cylinder being empty.

### CROSS-REFERENCE TO RELATED APPLICATION

This application claims priority pursuant to 35 U.S.C. 119(e) of U.S. provisional patent application No. 61/136,437, filed Sep. 5, 2008.

### BACKGROUND OF THE PRESENT INVENTION

Industrial gas cylinders are used for many types of medical, industrial and specialty gases, including oxygen, nitrogen, acetylene, among others. Typically, gas bottles containing such gases need to be tagged or labeled so that both the user and refiller can easily identify if the gas bottle is empty or full and also who owns the bottle.

Compressed gas presents a variety of hazards depending upon the identity of the gas. Gas may be flammable or combustible, explosive, corrosive, poisonous, inert, or a combination thereof. Accordingly, careful handling of such compressed gases is necessary, as well as the cylinders, regulators, valves and piping associated with the delivery of such gases.

Proper identification of gases in a cylinder is accordingly important. For instance, cylinders are painted to identify whether the gas in the cylinder is oxygen (green) or air (yellow). However, the color of the cylinder is not foolproof, as the color coding of the cylinder may change with the supplier. Identification of a gas may also be stenciled or stamped on the cylinder or label.

A variety of tags or labels are accordingly used to label gas cylinders. For instance, plastic collars of different configurations, such as circular, triangular, square, etc., have been used with advantage. Such collars fit about the neck portion of the cylinder, and may include information thereon regarding the type of gas, the identity of the customer, etc.

See, for instance, U.S. Pat. Nos. 5,249,380; 5,555,655; D508,957; and D500,806, among others, which depict the use of informational collars on gas cylinders. Various types of collars have also been used on other types of containers, as shown by U.S. Pat. Nos. 1,353,531; 5,947,672; and 6,321,473.

However, absent some type of written indication on the collar itself, such collars do not provide any information regarding the fill status (filled/unfilled) of the cylinder. Such information would be useful to the user/distributor of the gas cylinder to confirm whether the cylinder is filled with the desired gas, or is in need of being returned and refilled by the distributor.

### OBJECTS AND SUMMARY OF THE INVENTION

It is thus an object of the present invention to provide a collar for an industrial gas cylinder which not only identifies the type of gas or the distributor or customer of the gas in a particular cylinder, but also readily indicates the fill status of the cylinder. Such an invention is of particular benefit to the industrial gas industry, both from the standpoint of convenience, but also from the standpoint of safety.

In accordance with the present invention, there is thus provided a removable collar for use in connection with an industrial gas cylinder that may be readily inserted in engaging relationship over the neck of the gas cylinder, which collar also has on one side thereof at least one pre-selected indicia color denoting, for example, the type of gas in the cylinder, the distributor of the gas, and/or user-customer, and on the other side of the collar, a different pre-selected indicia color that denotes that the cylinder is empty.

### BRIEF DESCRIPTION OF THE DRAWINGS

FIG. 1 is a top view of one embodiment of the gas cylinder collar of the present invention having a circular through hole therein and being circular in dimension.

FIG. 2 is a top view of another embodiment of the gas cylinder collar of the present invention having a through hole defined by tabs and being circular in dimension.

FIG. 3 is a top view of another embodiment of the gas cylinder collar of the present invention having a through hole defined by tabs and being square in dimension.

FIG. 4 is a top view of another embodiment of the gas cylinder collar of the present invention having a through hole defined by tabs and being triangular in dimension.

FIG. 5 is a cross-sectional view of the embodiment of FIG. 1 wherein the collar is formed from two laminated layers.

FIG. 6 is a cross-sectional view of the embodiment of FIG. 1 wherein the collar is formed from a core layer and opposing surface layers laminated to the core layer.

FIG. 7 is a top view of another embodiment of the gas cylinder collar of the present invention having a circular through hole therein and being circular in dimension, whereby the top layer includes separate segments of different colors.

FIG. 8 is a bottom view of the embodiment of FIG. 1.

### DETAILED DESCRIPTION OF THE INVENTION

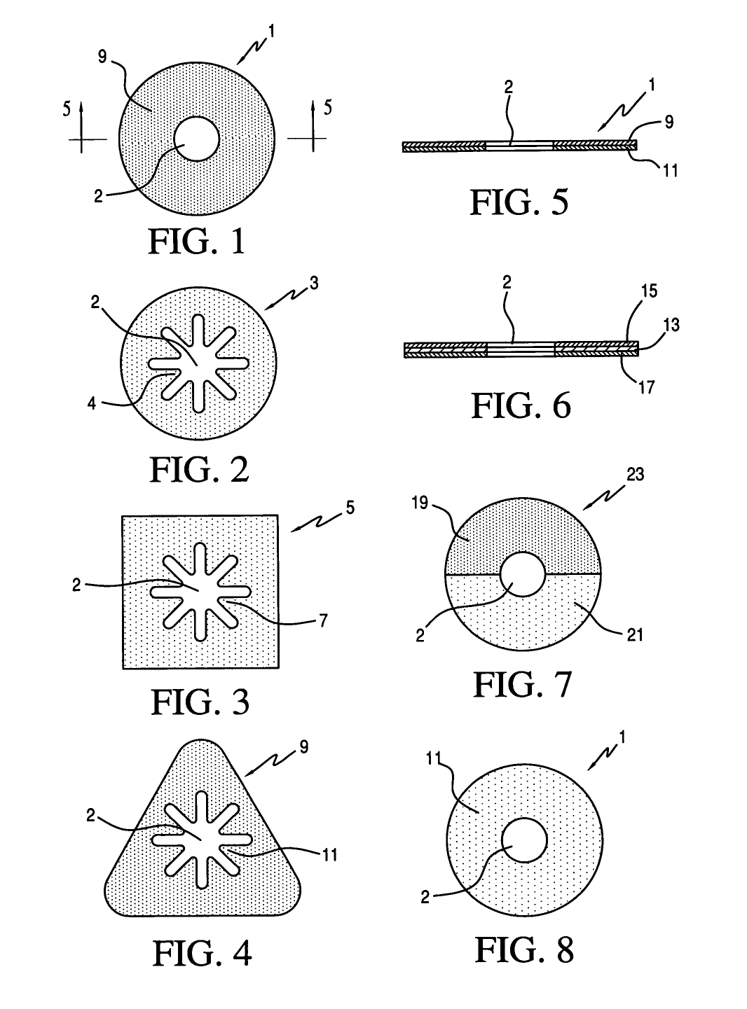

The present invention will be described in conjunction with the accompanying drawings, where FIGS. 1-8 depict various embodiments of the gas cylinder collars of the present invention.

The color-coded gas cylinder collar of the present invention is planar and includes a through-hole generally centrally positioned in the collar. While the collar may have a circular through hole for insertion over the cylinder head, it is preferable to employ at least one resilient tab extending from the periphery of the hole to the interior of the hole to assist in placement of the collar over the cylinder head. The at least one tab permits the top of the gas cylinder to be inserted into the hole due to the flexing of the at least one resilient tab, with the collar engaging the neck of the cylinder when inserted over the cylinder head. The at least one resilient tab then closes about the neck of the cylinder head, and remains in place when the cylinder head cover is removed so that the cylinder valve stem may be accessed by a gas user. Resilient tabs 4 (FIGS. 2), 7 (FIGS. 3) and 11 (FIG. 4) are shown in the Figures. While the collar is planar prior to being placed over the gas cylinder head, the collar may be flexed into a non-planar configuration during use due to flexing of the collar about the cylinder head.

In accordance with the present invention, one side of the gas cylinder collar includes at least one indicia color indicative of desired identifying information (such as, for example, the type of gas contained in the cylinder, and/or the customer), while the other side of the gas cylinder collar includes an indicia color that signifies that the gas cylinder is empty.

The respective indicia colors are intended to convey such information absent any wording—that is, it is not intended that any wording that may also convey such information be formed of the respective indicia colors. Instead, the gas collar is, in essence, color-coded due to the presence of the indicia colors on opposite surfaces of the collar. Thus, while wording may be present on the collar, the particular color of the wording is not intended to convey such information, and is not deemed to be comprised of such indicia colors.

In further description of the invention, FIG. 1 depicts a gas cylinder collar 1 which is circular in configuration, having a circular center hole 2. FIG. 2 depicts a gas cylinder collar 3 which is circular in configuration, having flexible tabs 4 which assist in mounting the collar about the valve cover. FIG. 3 depicts a gas cylinder collar 5 which is square in configuration, having flexible tabs 7 which assist in mounting the collar about the valve cover. FIG. 4 depicts a gas cylinder collar 9 which is triangular in configuration, having flexible tabs 11 which assist in mounting the collar about the valve cover. FIG. 5 depicts a gas cylinder collar 1 of the present invention in cross-section, depicting the presence of two laminated polymeric sheets 9, 11 of different colors forming opposing sides of the collar. FIG. 6 depicts a cross-section of a gas cylinder collar similar to that of FIG. 1 but comprised, in another embodiment, of a core layer 13 and opposing laminated surface layers 15, 17, with the opposing surface layers 15, 17 being of different colors. FIG. 7 depicts a gas cylinder collar 23 which is circular in configuration, having a circular center hole 2 and segments 19, 21 of differing colors on a top surface thereof. The bottom surface of collar 23 is of a different color than those of segments 19, 21. The same applies to each of the collars of FIGS. 1, 2, 3 and 4—the bottom surfaces of the depicted collars bear a different indicia color than is present on the top surface of the collars. For instance, FIG. 8 depicts the use of a different indicia color on the bottom of the collar shown in FIG. 1.

It is also clear from the Figures that the gas cylinder collar of the present invention may be comprised of any suitable shape, as long as the collar is capable of being placed about the cylinder head.

The collar may include a slit or cut portion that extends from the periphery of the collar to the edge of the hole in the collar. Such a slit or cut may ease installation of the collar about the gas cylinder head by permitting the respective free portions of the collar formed by the slit or cut to be separately flexed about the cylinder head, while still permitting the collar to be retained in secure relationship about the gas cylinder head during use of the cylinder. The slit or cut portion may, for instance, be formed along a straight line from an edge of the collar to the outer periphery of the hole, or may extend in a curved manner from an edge of the collar to an outer edge of the hole. The particular configuration of such a slit or cut is not critical to practice of the present invention.

In the gas cylinder collar of the present invention, one side of the gas collar bears at least one pre-selected indicia color, while the other side of the gas collar (indicating that the cylinder is empty) bears a different pre-selected indicia color. The at least one indicia color of one side of the collar denotes, for example, one or more of the type of gas in the gas cylinder and/or the source of the gas, and/or the customer. For instance, while this side of the collar will generally be comprised of a single indicia color (denoting, for instance, the type gas), this side of the collar may also comprise segregated segmented portions 19, 21 (FIG. 7) having different indicia colors (such as one-half of a circular collar being one color, and the other half being another color, or any variation of such portions area-wise such as ⅔ and ⅓, etc.), with one color identifying, for example, the type of gas, and the other color identifying the source of the gas or cylinder. This is the side of the collar that is viewable when the cylinder is filled with gas. Such an embodiment is depicted in FIG. 7.

The other side of the gas collar bears a single indicia color that denotes the fill status of the cylinder—i.e., generally that the cylinder is empty and in need of being refilled. The respective indicia colors will accordingly be different from one another. This is the side of the collar that is not viewable when the cylinder is filled, and faces downwardly when the collar is placed over the cylinder head.

Thus, in use, when the cylinder becomes empty or in need of being refilled, the collar is reversed on the cylinder such that the bottom portion of the collar becomes visually viewable, and confirms via the indicia color that the cylinder is in need of being refilled. The cylinder in such circumstance can accordingly be segregated from other gas cylinders that are still filled with gas, and not in need of being refilled.

The combined information provided by both sides of the collar assists in safe use of the gas cylinder, as the identity of the gas in the cylinder may be known both upon use (so that the proper gas is used for its intended purpose) as well as during refilling (so that the cylinder is refilled with the proper gas). The user of the cylinder need merely to observe the initially viewable indicia color of the cylinder collar prior to use (if the indicia color denotes the type of gas), and reverse the collar on the cylinder when the cylinder becomes empty to expose the other different indicia color indicative of the gas cylinder being empty.

The cylinder gas collar of the present invention may be formed of any suitable material. Preferably, the gas collar is formed from a suitable polymeric material such as polypropylene/polystyrene or polyethylene. Coated (weather-proofed) cardboard may also be used to form the gas collar. The gas collar may be formed by suitable molding methods when formed of a polymeric material(s). For instance, the collar may be formed by injection molding, an extruded sheet that is die cut, casting, etc. Such methods are well known to those skilled in the art.

Each side of the collar will have a different color, which may be inherent to the polymer forming the collar due to the presence of colorants, etc., or which may be present in an adhered colored layer, etc. One of ordinary skill in the art can readily provide a suitably colored polymeric layer having the desired color scheme. FIG. 5 depicts an embodiment where opposing co-extruded layers 9, 11 are of a different color. FIG. 6 depicts an embodiment where layers 15, 17 are of different indicia colors consistent with the invention. Two-sided colored collars can be readily produced by conventional methods such as co-extrusion, co-injection, lamination, in-mold labeling, etc.

Alternatively, layer 9 may serve as a core layer to which a colored layer 11 is attached by means such as an adhesive.

If a colored layer is formed by the presence of an applied colored layer, such layer may be any suitable layer which corresponds to the shape of the collar, and may be applied and adhered to the collar by suitable means, such as by use of a pressure sensitive adhesive, lamination, etc. Any such additional colored layer may be comprised of any suitable material, such as another polymeric layer, a paper layer, etc. Such adhered layer would preferably be coated, etc. to provide the requisite weatherproofing to protect the layer from the elements during storage and/or transport of the labeled gas cylinder. FIG. 6 depicts an embodiment where a core layer 13 has adhered thereto (either by adhesive or by co-extrusion) surface layers 15, 17 of differing colors. In such an embodiment, core layer 13 provides structural integrity to the gas cylinder collar.

While the respective indicia colors preferably comprise the entirety of the respective opposing surfaces of the collar, such is not required. That is, the respective opposing surfaces need only comprise sufficient area of said indicia colors to provide the desired visual indication of, on the one hand, for example, the type of gas, the customer, the source of the gas or cylinder, etc., and on the other hand, the fill status of the gas cylinder (i.e., that it is empty). As shown in FIG. 7, ½ of the top surface is comprised of one color, and ½ of the surface is comprised of another color. Alternatively, ½ of the top surface can comprise an indicia color, with the other ½ of the surface being dedicated to labeling of some type (such as, for instance, type of gas, etc.). The same may apply to the bottom surface of the gas collar, where the indicia color indicating that the gas cylinder is empty may comprise, for instance, ½ or ⅓ of the bottom surface of the collar instead of the entire bottom surface of the collar.

It may also be useful in certain instances to provide lettering in addition to the required indicia colors, such as the word EMPTY on a, for instance, red or black (indicia color) background. In such an instance, the indicia color red or black can visually reinforce the meaning of the word EMPTY.

The identity of the indicia color is not critical to practice of the invention. For instance, the color black may be used on one side of the collar to signify that the gas cylinder is empty, while the color green may be used on the other side to identify, for instance, a specific customer to whom the gas cylinder is to be delivered. In such an instance, a variety of gas collars may be used, with an indicia color for one side being assigned to identify a specific customer, with the other side of the collar being or bearing the color black, for instance, to signify that the cylinder is empty. Hence, when the cylinder is delivered, the side of the collar will be showing that exposes the indicia color assigned to that customer. When the cylinder is empty, the collar is reversed on the head of the cylinder to show the indicia color black (or whatever color is assigned to indicate that the cylinder is empty). It is then easy to differentiate between empty and full gas cylinders based on the color of the gas cylinder collar.

Preferably, the gas collar may be formed from separate sheets of polymer, with each sheet being formed from a polymer having a different color. Such multiple sheets of polymer (having dispersed therein the desired colorants) may be co-extruded onto each other, or combined by any convenient conventional method, such as by hot melt adhesion, laminating, two-shot injection molding, in mold labeling, etc. The particular method is not critical to the present invention, and is well within the ability of one of ordinary skill in the art.

What is claimed is:

1. A gas cylinder collar comprising a planar collar having a through-hole generally centrally positioned in the collar, said collar having opposing surfaces, one of said surfaces being comprised of at least one pre-selected indicia color, and said opposing surface being comprised of a different pre-selected indicia color, said respective indicia colors on one of said opposing surfaces being indicative of one or more of the type of gas in the gas cylinder and/or the source of the gas, and/or the customer, while the indicia color of the opposing surface being indicative of the gas cylinder being empty.

2. The gas cylinder collar of claim 1, wherein said collar has a circular through-hole for insertion over a gas cylinder head.

3. The gas cylinder collar of claim 1, wherein said through-hole includes at least one resilient tab extending from the periphery of the hole to the interior of the hole to assist in placement of the collar over the cylinder head.

4. The gas cylinder collar of claim 1, wherein said collar comprises a laminate of co-extruded polymeric layers of different colors.

5. The gas cylinder collar of claim 1, wherein said collar comprises a laminate of a core polymeric layer, and outer layers attached to opposite sides thereof, said outer layers each being of a different pre-selected color.

6. The gas cylinder collar of claim 1, wherein one side of said collar includes at least two pre-selected colors each within a separate segmented portion of said one side of said color.

7. The gas cylinder collar of claim 1, wherein said respective colors of indicia comprise the entirety of said opposing surfaces of said collar.
